(19) United States
(12) Patent Application Publication
(10) Pub. No.: US 2006/0032038 A1
(43) Pub. Date: Feb. 16, 2006

(54) Phosphorescent power conducting device

(76) Inventor: Marie L. Burkle, Guilford, CT (US)

Correspondence Address: Carmody & Torrance, 50 Leavenworth Street, P.O. Box 1110, Waterbury, CT, 06721-1110, US

(21) Appl. No.: 10/917,527

(22) Filed: Aug. 13, 2004

(51) Int. Cl. H01S 4/00

(52) U.S. Cl. 29/592.1; 29/825; 29/33 F

(57) ABSTRACT

A phosphorescent power conducting device including an electricity conductor covered with a glow-in-the-dark jacket. The jacket is formed from a resinous material mixed with a color concentrate. The jacket glows after exposure to light so as to increase visibility of the conducting device.

### BACKGROUND OF THE INVENTION

1. Field of the Invention

This invention relates to a power conducting device. More specifically, the present invention relates to a power cord that provides a visible indicator of its location in reduced lighting areas.

2. Description of the Related Art

Many power cords are provided that blend in with or complement the electrical devices to which they conduct power from an outlet. An extension cord can also be used to connect the power cord of a powered electrical device to an outlet. Extension cords are regularly used in all aspects of electricity conducting. However, extension cords are also more abused than power cords, in that they are often distanced from the powered device. More often than not, extension cords are pulled, twisted, tied and taped, and used in a variety of conditions that are different from how a power cord directly attached to the powered device would be used. As a result, a person's mental connection between stepping on the extension cord and displacing a lamp is more remote than if the person was to directly step on the lamp's power cord. For example, the extension cord may extend from indoors to outdoors, far from the location of the powered item in use.

Further, extension cords are currently manufactured in such a manner that they cannot be easily seen in the dark, which leads to the cords becoming tripping hazards, which can result in injury to individuals, electrical accidents, and physical damage to powered devices. Therefore, there is a need for an improved power cord that is safer by providing increased visibility, particularly in reduced lighting areas.

### SUMMARY OF THE INVENTION

The present invention relates to a cord for supplying power to a powered device, the cord being made from a material that emits light also interchangeably referenced to herein as a “glow-in-the-dark feature”). By glowing in the dark the power cord provides a visual indicator of its location in reduced lighting areas. Such cords can be used in applications including, but not limited to, telephone and other communication cables, network patch cables, audio visual cables, lamps, clocks and other home appliance cords, optical cables, printer cables, Universal Serial Bus (USB) cables, computer and keyboard cables, power cables, medical and dental industries and video/monitor cables. The glow-in-the-dark features of the power cords make moving or working around the cords safer in reduced lighting areas.

In one embodiment, the present invention is directed to phosphorescent power cords that can be straight power cords, or straight extension cords.

In a second embodiment, the invention is directed to phosphorescent retractile extension cords. Retractile cords extend only as far as necessary, which generally reduces the amount of loose cord extended and lessens the need to roll up long extension cords. The retractile cords can be made in any length, size or ratio to accommodate the particular power need.

As noted above, the cords can have applications with any electrically operable devices such as communications equipment, home and small appliances, power tools, and industrial machinery.

Additional advantages and novel features of the invention are set forth in the attachments to this summary, and in part will become more apparent to those skilled in the art upon examination of the following or upon learning by practice of the invention.

### BRIEF DESCRIPTION OF THE DRAWINGS

The features of the invention will be more readily understood with reference to the following description and the attached drawings, wherein:

FIG. 1 illustrates a retractile cord having plug ends in accordance with an embodiment of the present invention;

FIG. 2 illustrates a cross sectional view of a power cord having a phosphorescent cord in accordance with an embodiment of the present invention;

FIG. 3 illustrates a phosphorescent retractile cord in accordance with an embodiment of the present invention; and

FIG. 4 illustrates glowing retractile cords in accordance with an embodiment of the present invention.

### DETAILED DESCRIPTION OF THE INVENTION

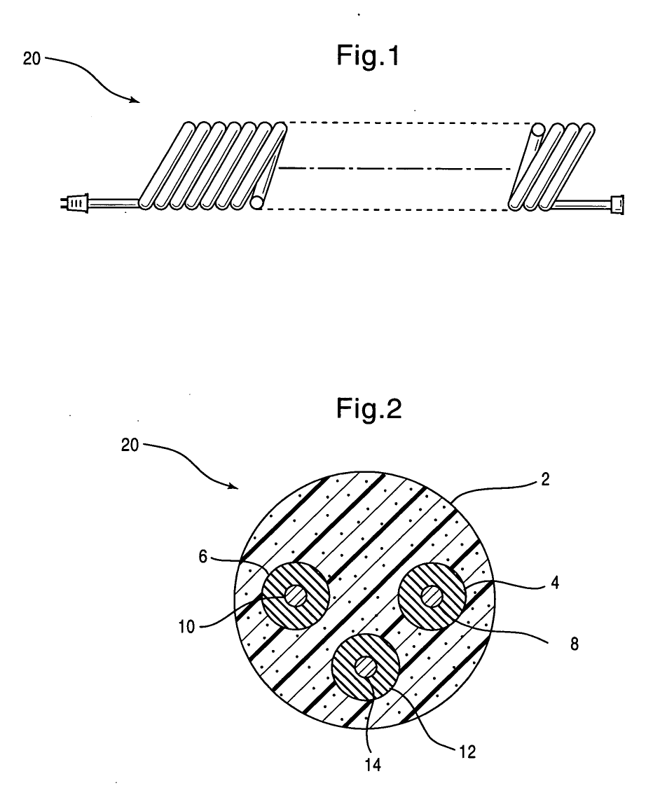

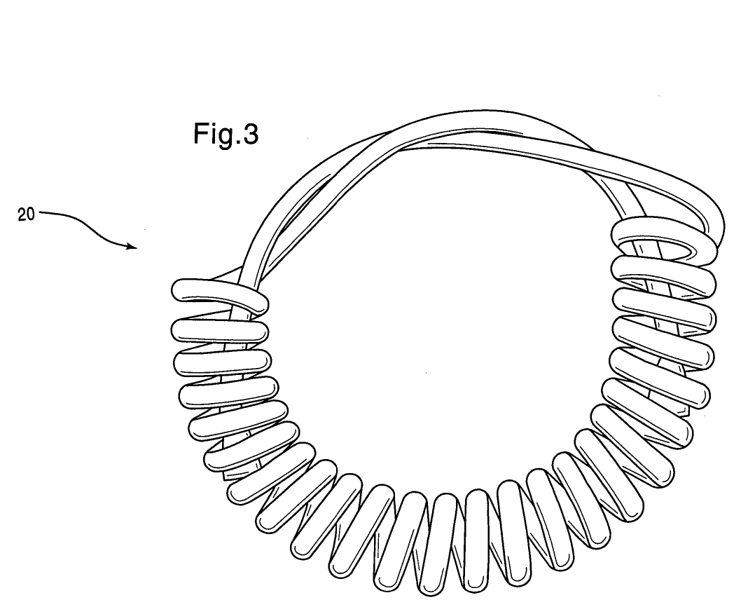

The present invention is directed to power cords that have phosphorescent capabilities. The cords can be power cords having a plug portion that connects an electrical device to an outlet, as shown for example, in FIG. 1. As shown in the cross-sectional view of FIG. 2, the cord can be a standard power cord 20, having a pair of wires 8, 10 for conducting electricity and a grounding wire 14 encased in insulating materials 4, 6, 12, respectively, such as Polyvinyl Chloride (PVC) or polypropylene. The power cord 20 can be encased in a conductor jacket 2 having phosphorescent properties. It is to be understood that the cord can be any cord or conduit for the conduction of power. In some embodiments, the conductor jacket is flame retardant.

The glow-in-the-dark feature can enhance safety in the workplace because the power cord 20 is more visible in reduced lighting areas than cords that do not emit light. The glow-in-the-dark feature can also be for decorative purposes, as a variety of colors can be tailored to suit the surroundings.

In one embodiment of the present invention, the phosphorescent extension cords can be helical or retractile, as shown in FIG. 3. Retractile cords are also known as, for example, coiled cords, cord sets, curly cords, and pigtails. Retractile cords extend only to a length necessary, thereby preventing excess cord from being tangled or becoming a tripping hazard. As a retractile cord, the cord extends only as far as necessary, reducing the need to roll up long extension cords. The cords can be formed from Polyvinyl Chloride (PVC), Thermoplastic Elastomer (TPE), or any other material suitable for forming power cords. The retractile cords can be made in any length, size or ratio to accommodate any power conducting need. For example, the retractile cord can be made to extend from less than a 1:1 ratio to a 1:5 ratio or more.

The power cords can be formed in any cross-sectional shape or curvature, depending on the required or desired application. For example, the power cords can also be straight (e.g. uncoiled).

In one example of the present invention, the power cords or conductors can be formed to include at least two wires for conducting electricity. Each wire of the conductor can be covered in an insulated coating formed from, for example, PVC or polypropylene. A resinous jacket is applied to cover the insulated coating.

In order to produce the glow-in-the-dark feature in one embodiment of the present invention, the jacket material incorporates a color concentrate introduced through a color compound. In one embodiment, the color compound is a phosphorescent color concentrate supplied by Breen Color Concentrates of Lambertville, N.J., USA. It is to be understood, however, that the jacket can be made of any can be made of any suitable plastic or other material to which may be added any phosphorescent, fluorescent, and/or phosphorescent dye or pigment that produces a glow-in-the dark effect.

For example, color concentrates can include alkaline earth metal aluminates such as Strontium, Magnesium, Calcium, and Barium. Silicon and Titanium may also be present. The earth metals can also be treated with Europium. Adding an opaque fluorescent pigment to the earth metals and then adding the jacket material thereto can make a phosphorescent jacket. The resulting jacket is visible in a lighted environment, while the fluorescent pigments allow the jacket to glow in the dark. Zinc sulfide, which produces a green glow can also be incorporated into the color concentrate. Colors created by the color concentrates can include, but are not limited to, orange, green, yellow, purple, and blue.

In one embodiment, the jacket is formed using a pelletized resinous material that is mixed with a pelletized color concentrate in a hopper. The ratio of resinous material to color concentrate is about 3 to 1. The jacket material and the color concentrate are heated in an extruder to form a viscous composite. The viscous composite is extruded through a head portion of a barrel and run onto the power conduction core, such as a cable or insulated electric wires. The extruded composite thereby forms a tubular member or jacket around the power conduction core device. The jacket with the color concentrate is then passed through a trough of water having a temperature of about 45 degrees Fahrenheit. The water in the trough can remain cool by being connected to a chiller or other temperature reducing device. Cured the jacket occurs instantaneously when it is passed through the trough.

In order to produce the retractile or coil feature of the present invention, the jacket can be wrapped around a mandrel and paced in an oven at a temperature of about 300-375 degrees Fahrenheit for approximately 20 minutes. Then the jacket is cooled at room temperature. After about 45 minutes into the cooling process, the jacket can undergo a reversing process by which the jacket is removed from the mandrel and reversely coiled to produce the retractile feature.

Although the pelletized resinous material and color concentrate can be mixed together prior to heating, they can also be heated independently of each other and then mixed together to form the viscous composite.

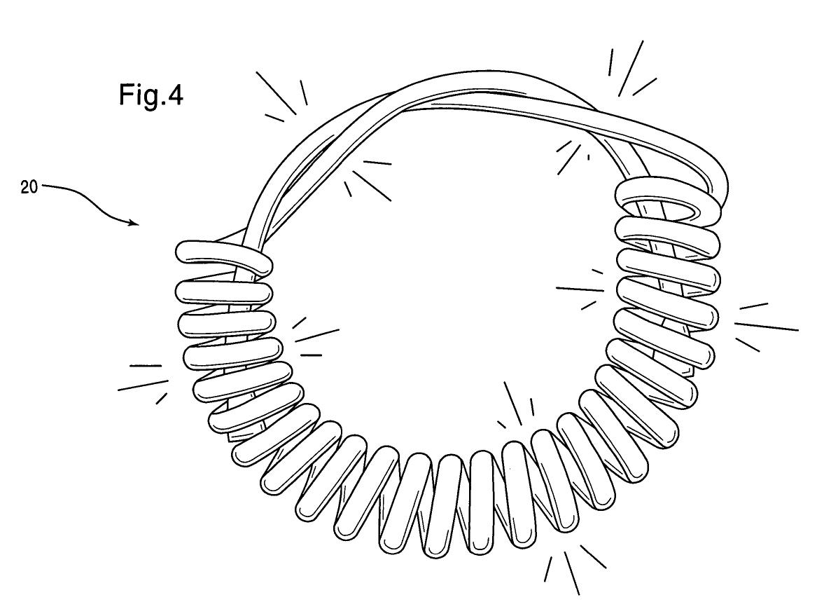

As a result of manufacture in accordance with the present invention, the jacket has properties that allow it to be phosphorescent for a predetermined period of time after exposure to light. (See FIG. 4, which illustrates the cord glowing after being exposed to at least one of a fluorescent, incandescent or ultraviolet light or sunlight) For example, in one embodiment, after one hour of exposure to light, the cords will glow for eight hours; after two hours of exposure to light, the cords will glow for sixteen hours; and after three hours of exposure, the cords will glow-in-the-dark for 24 hours. As such, each cord of the present invention has phosphorescent properties that linearly increase based on the time that the cord is exposed to light. In some embodiments, the cord glows whether or not electricity is flowing in the cord.

In another embodiment of the present invention, any color concentrate can be used, the cord can glow in any color.

In a further embodiment of the present invention, the cord can be coated with a glow in the dark paint that provides the same length of glowing time based on the time that the cord is exposed to light.

Example embodiments of the present invention have now been described in accordance with the above advantages. It will be appreciated that these examples are merely illustrative of the invention. Many variations and modifications will be apparent to those skilled in the art.

1-14. (canceled)

15. A method of making a phosphorescent power conducting device, the method comprising:
mixing a thermoplastic resinous material with a phosphorescent color concentrate;
heating the thermoplastic resinous material with the phosphorescent color concentrate to form a viscous composite;
extruding the viscous composite through a heated barrel onto a power conductor core to form a covering enclosing the power conductor core; and
exposing the covering to a liquid having a temperature of about 45 degrees Fahrenheit to cure the covering,
wherein the covering has the property of emitting light after exposure to light.

16. The method of making a phosphorescent power conducting device according to claim 15, wherein the step of exposing the covering to the liquid comprises exposing the covering to water.

17. The method of making a phosphorescent power conducting device according to claim 15, further comprising the step of coiling the covering over a mandrel and then reverse coiling the covering to form retractile member.

18. The method according to claim 15, wherein mixing the resinous material with the color concentrate includes:
mixing a pelletized resinous material and a pelletized color concentrate.

19. The method according to claim 15, wherein the step of curing the covering further comprises the steps of baking the covering at a temperature of about 300 degrees Fahrenheit to about 375 degrees Fahrenheit, and then cooling the covering at room temperature for at least about 45 minutes.

20. (canceled)
